(19) United States
(12) Patent Application Publication
(10) Pub. No.: US 2022/0099952 A1
(43) Pub. Date: Mar. 31, 2022

(54) LIGHT RECEIVING DEVICE FOR OPTICAL COMMUNICATION APPARATUS

(71) Applicant: Shimadzu Corporation, Kyoto (JP)

(72) Inventors: Ryosuke NISHI, Kyoto (JP); Kazutomo KADOKURA, Kyoto (JP); Mamoru HISAMITSU, Kyoto (JP); Kazuya INOUE, Kyoto (JP)

(21) Appl. No.: 17/038,504

(22) Filed: Sep. 30, 2020

(51) Int. Cl. G02B 19/00; G02B 7/02; G02B 27/30; G02B 5/20; H04B 10/67; H04B 10/11

(52) U.S. Cl. CPC G02B 19/0076; G02B 7/02; H04B 10/11; G02B 5/20; H04B 10/67; G02B 27/30

(57) ABSTRACT

A light receiving device of optical communication equipment includes a condenser lens configured to condense incident light, a collimation lens having a focal length shorter than a focal length of the condenser lens, the collimation lens being configured to convert light from the condenser lens to parallel light, a bandpass filter having a filter surface on which the parallel light from the collimation lens is perpendicularly incident, the bandpass filter being configured to transmit only a wavelength of the incident light, and a light receiving element configured to detect light transmitted through the bandpass filter.

### BACKGROUND

### Technical Field

The present disclosure relates to a light receiving device of optical communication equipment for performing communication between distant points by optical signals.

### Related Art

Optical communication equipment includes a light source disposed on the transmitting side and a light receiving unit disposed apart from the light source on the receiving side. According to this optical communication equipment, the light receiving unit receives the modulated light signal from the light source to perform communication between the transmitting side and the receiving side.

For example, in the optical communication equipment described in Patent Document 1, laser beam from a semiconductor laser as a light source is converted into parallel light by a collimation lens, and an optical signal is transmitted to space. The transmitted optical signal is received by the light receiving unit through a condenser lens and a bandpass filter.

In addition, underwater optical radio communication techniques are known. Patent Document 2 discloses an underwater communication system in which transmission and reception of various kinds of data are performed between underwater devices using optical signals. Patent Document 3 discloses an underwater visible-light communication system in which observation data is transmitted to an underwater mobile target using visible-light communication from an observation device installed underwater.

The light receiving techniques of optical wireless communication had the following three problems.

(1) As the distance between the light source and the light receiving unit increases, light is absorbed and diffused by fine particles in the air and water, as well as water and rain, so the amount of light is attenuated.

(2) In addition, the window of the light receiving housing cannot be enlarged in order to reduce the size of the device and to use the light receiving housing in water or sea where high water pressure is applied.

(3) Furthermore, since optical noise, such as, e.g., sunlight, greatly affects the optical signal receiver sensitivity, noise removal is necessary.

For the above-described problems (1) and (2), it is effective to use a condenser lens because the light transmitted through the window of the light receiving housing can be effectively condensed on the light receiving unit. For the above-described problem (3), it is useful to use a bandpass filter that transmits only a wavelength used for optical communication.

Also, in order to take advantage of the single wavelength characteristic of the laser beam, it is useful to use a filter that transmits only a narrow wavelength width. For this reason, a dielectric multilayer filter is used for a narrowband bandpass filter. In Patent Document 1, a condenser lens and a bandpass filter are used to solve the above-described three problems.

### PRIOR ART DOCUMENT

### Patent Document

Patent Document 1: Japanese Unexamined Patent Application Publication No. H07-177090

### Patent Document 2: Japanese Unexamined Patent Application Publication No. 2009-55408

### Patent Document 3: Japanese Unexamined Patent Application Publication No. 2009-278455

### SUMMARY OF THE INVENTION

### Problems to be Solved by the Invention

However, in the case of using a bandpass filter using a dielectric multilayer filter, the dielectric multilayer filter has angular dependence. As described in Patent Document 1, in the case of disposing a bandpass filter after a condenser lens, a dielectric multilayer filter causes angular dependence depending on the converging angle. That is, light from the center of the condenser lens is perpendicularly incident on the bandpass filter, but light from other than the center of the condenser lens is not perpendicularly incident on the bandpass filter. For this reason, there is a problem that filtering cannot be performed for an intended wavelength.

An object of the present disclosure is to provide a light receiving device of optical communication equipment capable of collecting light and performing filtering with respect to an intended wavelength.

### Means for Solving the Problem

In order to solve the above-described problems, a light receiving device of optical communication equipment according to the present disclosure, includes:

a first condenser lens configured to condense incident light;

a collimation lens having a focal length shorter than a focal length of the first condenser lens, the collimation lens being configured to convert light from the first condenser lens into parallel light;

a bandpass filter having a filter surface on which the parallel light from the collimation lens is perpendicularly incident, the bandpass filter being configured to transmit only a wavelength of the parallel light; and

a light receiving element configured to detect light transmitted through the bandpass filter.

Further, a light receiving device of optical communication equipment according to the present disclosure, includes:

a concave lens configured to convert incident light to parallel light;

a bandpass filter having a filter surface on which the parallel light is perpendicularly incident, the bandpass filter being configured to transmit only a wavelength of the parallel light from the concave lens;

a condenser lens configured to condense light transmitted through the bandpass filter;

and a light receiving element configured to detect the light condensed by the condenser lens.

According to the present disclosure, the light from the first condenser lens is converted into parallel light by the collimation lens, and the parallel light from the collimation lens is perpendicularly incident on the bandpass filter. Therefore, it is possible to condense the light, which enables filtering with respect to an intended wavelength.

Further, the incident light is converted into parallel light by the concave lens, and the parallel light from the concave lens is perpendicularly incident on the bandpass filter. Therefore, the light can be condensed, which enables filtering with respect to an intended wavelength.

### BRIEF DESCRIPTION OF THE DRAWINGS

FIG. 1 is a configuration diagram of a light receiving device of optical communication equipment of a first embodiment of the present disclosure.

FIG. 2 is a configuration diagram of a light receiving device of optical communication equipment of a second embodiment of the present disclosure.

FIG. 3 is a configuration diagram of a light receiving device of optical communication equipment of a third embodiment of the present disclosure.

FIG. 4 is a configuration diagram of a light receiving device of optical communication equipment of a fourth embodiment of the present disclosure.

FIG. 5 is a configuration diagram of a light receiving device of optical communication equipment of a fifth embodiment of the present disclosure.

FIG. 6 is a configuration diagram of a light receiving device of optical communication equipment of a sixth embodiment of the present disclosure.

FIG. 7 is a configuration diagram of a light receiving device of optical communication equipment of a seventh embodiment of the present disclosure.

### EMBODIMENTS FOR CARRYING OUT THE INVENTION

### First Embodiment

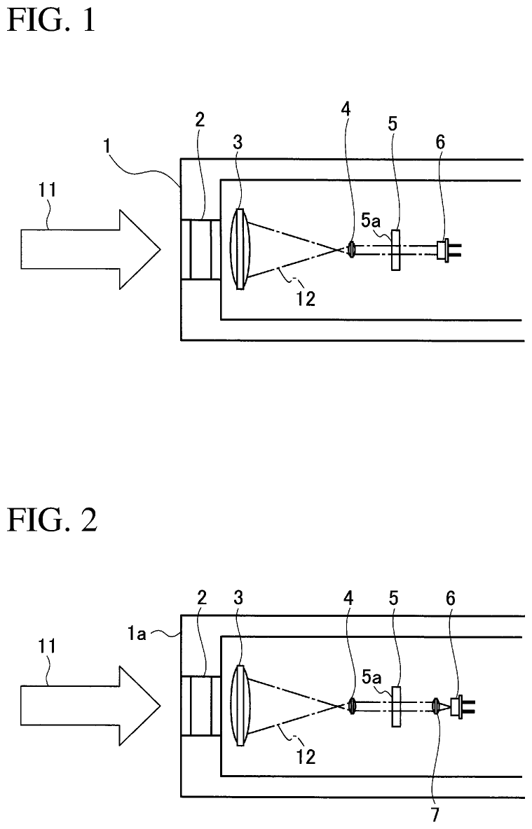

Hereinafter, a light receiving device of optical communication equipment according to an embodiment of the present disclosure will be described in detail with reference to the attached drawings. FIG. 1 is a configuration diagram of a light receiving device of optical communication equipment according to a first embodiment of the present disclosure. The light receiving device of optical communication equipment according to the first embodiment shown in FIG. 1 is provided with a light receiving housing 1 for receiving incident light 11. The incident light 11 is signal light emitted from a light source composed of a semiconductor laser or the like (not shown). It is supposed that the incident light is not incident at a constant angle via underwater propagation.

The light receiving housing 1 is composed of a laterally (horizontally) elongated cylindrical body made of aluminum or the like, and is provided with an optical window 2 for entering the incident light 11 on the left side surface of the cylindrical body. The optical window 2 is made of glass, acrylic resin, or the like.

In the cylindrical body of the light receiving housing 1, a condenser lens 3, a collimation lens 4, a bandpass filter 5, and a light receiving element 6 are arranged. The optical window 2, the condenser lens 3, the collimation lens 4, the bandpass filter 5, and the light receiving element 6 are arranged on the optical axis of the incident light 11.

The condenser lens 3 as a first condenser lens is composed of a convex lens or the like having a first focal length and is disposed in the vicinity of the optical window 2. The condenser lens is configured to condense the incident light 11 incident from the optical window 2 at the first focal length. The condensed light is light 12.

The collimation lens 4 has a second focal length shorter than a first focal length of the condenser lens 3 and converts the light condensed by the condenser lens 3 at the first focal length and then diverged, into parallel light.

The bandpass filter 5 is a bandpass filter that passes only a frequency of a predetermined bandwidth. For example, the bandpass filter is composed of a dielectric multilayer filter and has angular dependence. The bandpass filter 5 has a filter surface 5a on which the parallel light from the collimation lens 4 is perpendicularly incident and is configured to transmit only the wavelength of the incident light 11.

The light receiving element 6 is composed of, for example, a photodiode, and is configured to detect the light transmitted through the bandpass filter 5.

Note that the condenser lens 3 and the collimation lens 4 may be disposed on the outer side of the light receiving housing 1 and the optical window 2.

Thus, according to the light receiving device of optical communication equipment according to the first embodiment, the incident light 11 passes through the optical window 2 and is focused at the first focal length by the condenser lens 3. Furthermore, the light from the condenser lens 3 is converted into parallel light by the collimation lens 4, and the parallel light from the collimation lens 4 is perpendicularly incident on the surface 5a of the bandpass filter 5. Thus, the limited light is effectively filtered and guided to the light receiving element 6.

That is, the light from the center of the collimation lens 4 and the light from other than the center of the collimation lens 4 are parallel light. Therefore, they are perpendicularly incident on the surface 5a of the bandpass filter 5. As a result, it is possible to eliminate the angular dependence of the dielectric multilayer filter due to the converging angle. Therefore, the light can be condensed, which makes it possible to perform filtering with respect to an intended wavelength.

### Second Embodiment

FIG. 2 is a block diagram of a light receiving device of optical communication equipment according to a second embodiment of the present disclosure. In the light receiving device of optical communication equipment according to the second embodiment, compared with the light receiving device of optical communication equipment according to the first embodiment shown in FIG. 1, a condenser lens 7 as a second condenser lens is disposed between the bandpass filter 5 and the light receiving element 6 in the light receiving housing 1a.

The condenser lens 7 is composed of a convex lens or the like and is configured to condense the light transmitted through the bandpass filter 5 and guide it to the light receiving element 6.

According to the second embodiment, in a case where the parallel light transmitted through the collimation lens 4 is greater than the light receiving surface of the light receiving element 6, the light transmitted through the bandpass filter 5 is once condensed by the condenser lens 7 and then guided to the light receiving element 6. Therefore, limited light can be effectively detected by the light receiving element 6.

### Third Embodiment

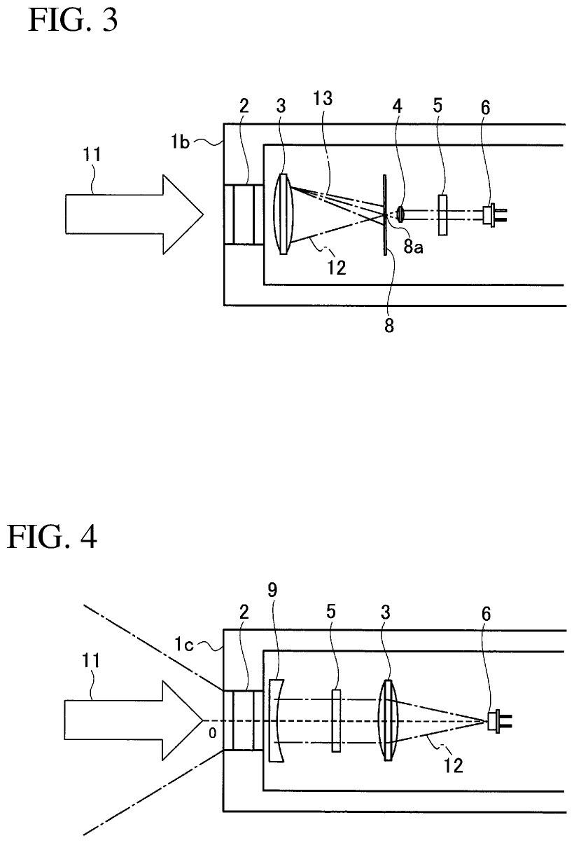

FIG. 3 is a configuration diagram of a light receiving device of optical communication equipment according to a third embodiment of the present disclosure. The optical communication equipment of the light receiving device according to the third embodiment shown in FIG. 3 is further provided with an aperture 8 between the condenser lens 3 and the collimation lens 4 in the light receiving housing 1b, as compared with the light receiving device of the optical communication equipment according to the first embodiment shown in FIG. 1. The aperture 8 is positioned at the focal position of the condenser lens 3.

The aperture 8 has an opening 8a and is configured to pass only light condensed at the focal position of the condenser lens 3 through the opening 8a and block light not condensed at the focal position of the condenser lens 3.

In cases where the angular dispersion of incident light is large, there is a case in which the light is not sufficiently condensed by the condenser lens 3 and the light cannot be converted into parallel light even by the collimation lens 4.

Note that in order to perform filtering of only a desired wavelength by the bandpass filter 5, the light is required to be perpendicularly incident on the surface 5a of the bandpass filter 5. For this reason, the aperture 8 is disposed between the condenser lens 3 and the collimation lens 4.

The aperture 8 is disposed at the focal position of the condenser lens 3, and the incident angle of stray light or the like to the condenser lens 3 is largely deviated. Therefore, light not condensed at the focal position of the condenser lens 3 is guided to a portion other than the opening 8a of the aperture 8 and therefore is blocked by the aperture 8.

In contrast, the light condensed at the focal position of the condenser lens 3 and transmitted through the opening 8a of the aperture 8 becomes parallel light by the collimation lens 4. This parallel light is perpendicularly incident on the surface 5a of the bandpass filter 5.

That is, even in cases where the angular dispersion of the incident light is large, the incident light can be condensed at the focal position of the condenser lens 3 by using the aperture 8. Therefore, the light can be converted into parallel light by the collimation lens 4 so that the parallel light can be perpendicularly incident on the surface 5a of the bandpass filter 5. As a result, the same effects as those of the light receiving device of optical communication equipment according to the first embodiment can be obtained.

Note that the light receiving device of the optical communication equipment according to the second embodiment and the light receiving device of the optical communication equipment according to the third embodiment may be combined. By configuring as described above, it is possible to obtain the effects of the light receiving device of the optical communication equipment according to the second embodiment and the effects of the light receiving device of the optical communication equipment according to the third embodiment can be obtained.

### Fourth Embodiment

FIG. 4 is a configuration diagram of a light receiving device of optical communication equipment according to a fourth embodiment of the present disclosure. In the light receiving device of optical communication equipment according to the fourth embodiment shown in FIG. 4, a concave lens 9, a bandpass filter 5, a condenser lens 3, and a light receiving element 6 are provided in a light receiving housing 1c. The concave lens 9, the bandpass filter 5, the condenser lens 3, and the light receiving element 6 are arranged on the optical axis of the incident light 11 and on the central axis O of the light receiving housing 1c.

The concave lens 9 is disposed in the vicinity of the optical window 2 and is configured to convert the incident light 11 incident from the optical window 2 into parallel light. The bandpass filter 5 is configured such that the parallel light from the concave lens 9 is perpendicularly incident on the filter surface 5a and only the wavelength of the incident light 11 is transmitted through the bandpass filter 5.

The condenser lens 3 condenses the light transmitted through the bandpass filter 5. The light receiving element 6 detects the light condensed by the condenser lens 3.

In the first to third embodiments, the incident light is converted into parallel light using the condenser lens 3 and the collimation lens 4. On the other hand, according to the fourth embodiment, in cases where the incident light 11 is incident at a large angle (for example, 60°) with respect to the central axis O of the light receiving housing 1c, it is possible to convert the incident light 11 into parallel light at a time by the concave lens 9. Therefore, the optical system can be simplified. In particular, it is effective in cases where the incident light 11 is incident at a large angle with respect to the central axis O of the light receiving housing 1c.

### Fifth Embodiment

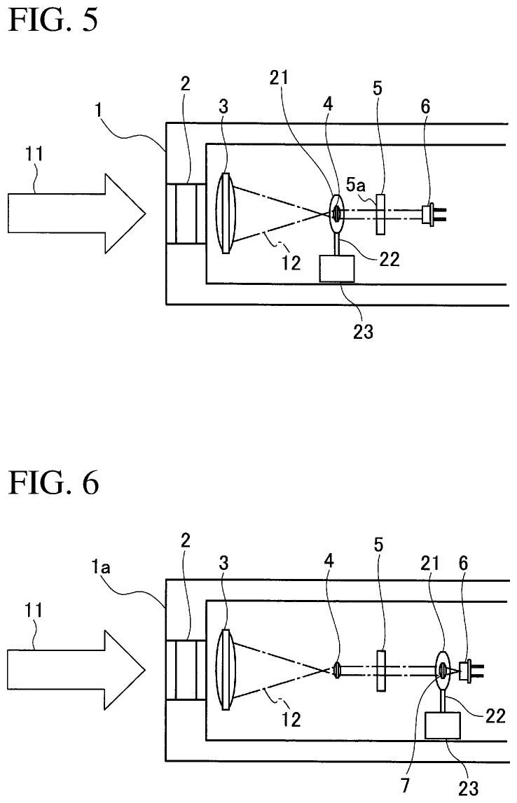

FIG. 5 is a configuration diagram of a light receiving device of optical communication equipment according to a fifth embodiment of the present disclosure. The light receiving device of optical communication equipment according to the fifth embodiment shown in FIG. 5 is provided with, in addition to the configuration of the first embodiment shown in FIG. 1, a holder 21 covering the collimation lens 4, a rod 22 coupled to one end of the holder 21, and an XYZ stage 23 coupled to the other end of the rod 22. The holder 21, the rod 22, and the XYZ stage 23 are provided in the light receiving housing 1.

The XYZ stage 23 as a moving mechanism is driven by a control signal from an outside of the light receiving housing 1 to move the collimation lens 4 in the holder 21 via the rod 22 in three-axis directions of the X-axis direction (lateral direction), the Y-axis direction (vertical direction), and the Z-axis direction (longitudinal direction).

Therefore, by driving the XYZ stage 23, it is possible to adjust the collimation lens 4 to the optimum position in accordance with the light incident angle.

### Sixth Embodiment

FIG. 6 is a configuration diagram of a light receiving device of optical communication equipment according to a sixth embodiment of the present disclosure. The light receiving device of optical communication equipment according to the sixth embodiment shown in FIG. 6 is provided with, in addition to the configuration of the second embodiment shown in FIG. 2, a holder 21 covering the condenser lens 7, a rod 22 connected to one end of the holder 21, and an XYZ stage 23 connected to the other end of the rod 22. The holder 21, the rod 22, and the XYZ stage 23 are provided in the light receiving housing 1.

The XYZ stage 23 as a moving mechanism is driven by a control signal from an outside of the light receiving housing 1 to move the condenser lens 7 in the holder 21 via the rod 22 in three-axis directions of the X-axis direction (lateral direction), the Y-axis direction (vertical direction), and the Z-axis direction (longitudinal direction).

Therefore, by driving the XYZ stage 23, it is possible to adjust the condenser lens 7 to the optimum position in accordance with the light incident angle.

Note that the light receiving device of the optical communication equipment according to the sixth embodiment and the light receiving device of the optical communication equipment according to the fifth embodiment may be combined. By configuring as described above, it is possible to obtain the effects of the light receiving device of the optical communication equipment according to the sixth embodiment and the effects of the light receiving device of the optical communication equipment according to the fifth embodiment can be obtained.

### Seventh Embodiment

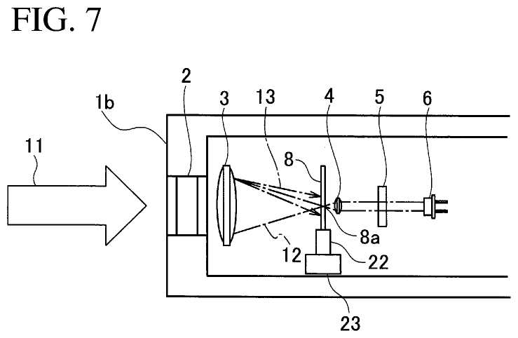

FIG. 7 is a configuration diagram of a light receiving device of optical communication equipment according to a seventh embodiment of the present disclosure. The light receiving device of optical communication equipment according to the seventh embodiment shown in FIG. 7 is further provided with, in addition to the configuration of the light receiving device of optical communication equipment according to the third embodiment shown in FIG. 3, a rod 22 coupled to one end of the aperture 8 and an XYZ stage 23 coupled to the other end of the rod 22. The rod 22 and the XYZ stage 23 are provided in the light receiving housing 1.

The XYZ stage 23 as a moving mechanism is driven by a control signal from an outside of the light receiving housing 1 to move the aperture 8 via the rod 22 in three-axis directions of the X-axis direction (lateral direction), the Y-axis direction (vertical direction), and the Z-axis direction (longitudinal direction).

Therefore, by driving the XYZ stage 23, it is possible to adjust the aperture 8 to an optimum position in accordance with the light incident angle.

Note that each of the light receiving devices according to the seventh embodiment, the sixth embodiment, and the fifth embodiment may be combined (integrated). According to this configuration, it is possible to obtain the respective effects of the seventh embodiment, the sixth embodiment, and the fifth embodiment.

1. A light receiving device of optical communication equipment, comprising:
a first condenser lens configured to condense incident light;
a collimation lens having a focal length shorter than a focal length of the first condenser lens, the collimation lens being configured to convert light from the first condenser lens into parallel light;
a bandpass filter having a filter surface on which the parallel light from the collimation lens is perpendicularly incident, the bandpass filter being configured to transmit only a wavelength of the parallel light; and
a light receiving element configured to detect light transmitted through the bandpass filter.

2. The light receiving device of optical communication equipment as claimed in claim 1, further comprising:
a second condenser lens disposed between the bandpass filter and the light receiving element, the second condenser lens being configured to condense the light transmitted through the bandpass filter and guide the condensed light to the light receiving element.

3. The light receiving device of optical communication equipment as recited in claim 1, further comprising:
an aperture disposed at a focal position of the first condenser lens between the first condenser lens and the collimation lens to block light not condensed at the focal position of the first condenser lens.

4. The light receiving device of optical communication equipment as recited in claim 2, further comprising:
an aperture disposed at a focal position of the first condenser lens between the first condenser lens and the collimation lens to block light not condensed at the focal position of the first condenser lens.

5. The light receiving device of optical communication equipment as recited in claim 1, further comprising:
a light receiving housing configured to house the collimation lens and a moving mechanism for moving the collimation lens in three-axis directions,
wherein the moving mechanism is driven by a control signal from an outside of the light receiving housing.

6. The light receiving device of optical communication equipment as recited in claim 2, further comprising:
a light receiving housing configured to house the second condenser lens and a moving mechanism for moving the second condenser lens in three-axis directions,
wherein the moving mechanism is driven by a control signal from an outside of the light receiving housing.

7. The light receiving device of optical communication equipment as recited in claim 3, further comprising:
a light receiving housing configured to house the aperture and a moving mechanism for moving the aperture in three-axis directions,
wherein the moving mechanism is driven by a control signal from an outside of the light receiving housing.

8. The light receiving device of optical communication equipment as recited in claim 4, further comprising:
a light receiving housing configured to house the aperture and a moving mechanism for moving the aperture in three-axis directions,
wherein the moving mechanism is driven by a control signal from an outside of the light receiving housing.

9. A light receiving device of optical communication equipment, comprising:
a concave lens configured to convert incident light into parallel light;
a bandpass filter having a filter surface on which the parallel light from the concave lens is perpendicularly incident, the bandpass filter being configured to transmit only a wavelength of the parallel light;
a condenser lens configured to condense light transmitted through the bandpass filter; and
a light receiving element configured to detect the light condensed by the condenser lens.
